(19) United States
(12) Patent Application Publication
(10) Pub. No.: US 2013/0080545 A1
(43) Pub. Date: Mar. 28, 2013

(54) AUTOMATIC ACCESS SETTINGS BASED ON EMAIL RECIPIENTS

(71) Applicant: Harmohit S. Datta, Redmond, WA (US)

(72) Inventor: Harmohit S. Datta, Redmond, WA (US)

(73) Assignee: Microsoft Corporation, Redmond, WA (US)

(21) Appl. No.: 13/246,863

(22) Filed: Sep. 28, 2011

(51) Int. Cl. G06F 15/16

(52) U.S. Cl. 709/206

(57) ABSTRACT

A system is provided for automatically designating access and permission settings for documents in a collaborative authoring environment. The system may automatically configure the access and permission settings based on an email message with a link to a document for collaborative editing. The system may determine that certain recipient users in the “CC:” line of the email message be granted read only access while other recipient users in the “To:” line of the email message be granted editing access. Designating the access and privilege settings for the linked document in the email may be transparent to the sender and the recipients of the email. The system may automatically designate the access and privilege settings to the linked document for the recipients of the email without requiring any external input by the sender of the email.

### BACKGROUND

In a collaborative authoring environment, multiple users may have access to a document for making changes to the document, adding to the document, leaving feedback and adding comments to the document. Often times an author of an original document may wish for other users in a collaborative environment to be able to view the document and make suggestions and changes to the document. Other times, a document may be authored by multiple users who collaborate together to generate a completed document, with input from the multiple users.

In the collaborative authoring environment, access and permission settings may be specified in order to designate which users may have access to a document for collaboratively authoring the document. Setting up document collaboration and configuring document access and permission settings may be a cumbersome and confusing process for users in the collaborative authoring environment. Configuring document access and permission settings may require using complex user interfaces and configuration modules for specifying which users have read access and which users have read and write access to documents within the collaborative authoring environment. Additionally, the users may be required to specify the access settings each time the document is shared, which may be complicated and time consuming

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to automatically designating access and permission settings for documents in a collaborative authoring environment. A system according to embodiments may automatically initiate a collaborative authoring environment upon the generation of an email message including a link to a document for collaborative editing. The system may automatically configure the access and permission settings based on the email message and determination of the users in the recipient designations of the email message. The system may determine that recipient users in the “CC:” line of the email message be granted read-only access. The system may also determine that recipient users in the “To:” line of the email message may be granted full access to the document for adding comments, feedback, authoring and editing the document.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates a system for automatically configuring document access settings from recipient designations of an email in a collaborative authoring environment, according to embodiments;

FIG. 2 illustrates a system for automatically configuring document access settings from recipient designations of an email in a collaborative server environment, according to embodiments;

FIG. 3 illustrates an example scenario for automatically configuring document access and permission settings in a collaborative authoring environment, according to embodiments;

FIG. 4 is a networked environment, where a system according to embodiments may be implemented;

FIG. 5 is a block diagram of an example computing operating environment, where embodiments may be implemented; and

FIG. 6 illustrates a logic flow diagram for a process of automatically configuring document access settings from recipient designations of an email, according to embodiments.

### DETAILED DESCRIPTION

As briefly described above, a system is provided for automatically designating access and privilege settings for documents in a collaborative authoring environment. The system may determine the types of access privileges for particular users based on initiation of a sent email message with a link to a document for enabling collaborative editing of the document. Based on the sent email message, the system may determine that certain recipient users have read only access while other recipient users of the email message have read/write privileges. Read only access to the document may be granted to recipient users in the “CC:” line of the email message. Read and write access may be granted to recipient users in the “To:” line of the email message. Designating the access and privilege settings for the linked document in the email message may be transparent to the sender and the recipients of the email message. The system may automatically designate the access and privilege settings to the linked document for the recipients of the email message without requiring any external input by the sender of the email message to specify which types of document access and privileges each recipient user has.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for providing email and/or collaborative authoring services. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

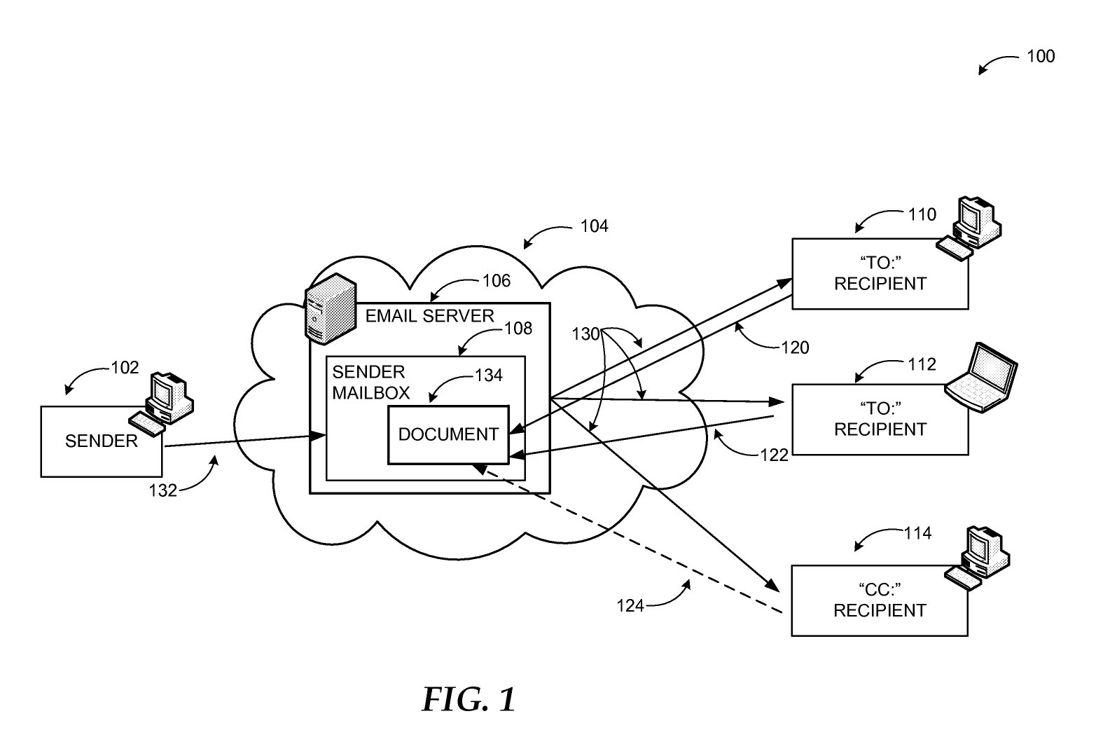

FIG. 1 illustrates a system for automatically configuring document access settings from recipient designations of an email in a collaborative authoring environment, according to embodiments. A system according to embodiments may enable setting up document collaboration for allowing multiple users to leave feedback, comments, author, and edit a document in a collaborative environment. The system may enable automatic initiation of a collaborative authoring environment when an email message is generated which includes a document or a link to the document. Upon the sending of the email message including the document or the link, the system may automatically set up access and permission rules for the linked document. The access and permission rules for the linked document may be automatically configured based on the designated recipients inserted in the recipient lines, or the To: line, the CC: line and/or the BCC: line, of the email message. The automatic configuration of the access and permission rules may be transparent to a sender 102 and to the recipients of the email message, such that no input or customization by the sender 102 may be necessary in order to designate the access and permission settings in the collaborative authoring environment.

As shown in diagram 100, the sender 102 may initiate a collaborative authoring environment upon sending out an email message (132) which may include a document or a link to the document, an application, or other authored file. For example, the document or authored file may be any type of document or other authored file such as a word processing document, a spreadsheet, an image, a video, a presentation document, a graphic design document, a calendar document, and an email message. Other documents or files may also be used in a similar manner. In a collaborative authoring environment, the document may be configured to enable two or more users to have access to the document for viewing and making edits to the document concurrently.

In an example embodiment, when the sender 102 initiates sending out the email message (132), an email server 106 may facilitate the email exchange forwarding (130) the email to recipients such as direct recipients (recipients in a To: line of the email) and indirect recipient (recipient in a CC: line or BCC: line of the email) over network(s) 104. Email server 106 may also maintain a mailbox 108 for the sender 102 with the senders email messages, contact information, etc. In some embodiments, document 134 may be stored in the sender's mailbox 108.

Email server 106 may set access privileges for the recipients based on their recipient designation. For example, To: line recipients 110 and 112 may be assigned complete access privileges including, but not limited to, read, edit, download, forward, delete, and store privileges. CC: or BCC: line recipients may be assigned limited (e.g., read-only) privileges. Thus, To: line recipients 110 and 112 may access (120 and 122) the document 134 in sender's mailbox 108 with complete access privileges, while CC: line recipient 114 may access (124) the document 134 with read-only privileges.

In a system according to embodiments, the email server 106 may automatically configure document access and document permission rules according to which recipient line the recipient is in. For example, the To: line may be configured to automatically grant the To: line recipient 110 complete access 120 to the document for complete collaborative authoring and editing capabilities. Additionally, the CC: line may be configured to automatically grant the CC: line recipient 114 limited or read only access 124 to the document for viewing and read only capabilities. Thus, in an example scenario, if the sender 102 wishes to collaborate with another user on a document such that the collaborating user has full authoring and editing capabilities for the document, the sender 102 may generate an email message, include the intended user in the To: line of the email message as the To: line recipient 110, and insert the document in the body of the email message. The email server 106 may automatically set the permission settings for the To: line recipient 110, granting the To: line recipient 110 complete access 120, so that the sender 102 does not have to manually input any special settings into the system for granting the user access to the document.

In another example embodiment, two or more recipients may be inserted in the To: line of the email message such that there may be two or more To: line recipients 110, 112 who may have full authoring or complete access 120, 122 to the document 134 stored in the sender mailbox 108 in the email server 106. The collaborative authoring environment may enable the two or more To: line recipients 110, 112 to access the document 134 at the same time from the sender mailbox 108 using the document link in the email message and to edit the document simultaneously. Additionally the sender 102 may also be able to access to the document in the sender mailbox 108 for simultaneous viewing and editing with the To: line recipients 110, 112.

In a system according to even further embodiments, the system may enable the sender 102 to customize and specify levels of document access and permissions. For example, the sender 102 may customize the document access settings to allow the CC: line recipient 114 to be able to read the document and also to insert comments and feedback on the document, but not to make changes or edits to the substantive content of the document. In another example scenario, the sender 102 may specify that the To: line recipient 110 may have complete access 120 for authoring and editing, but the document may enable tracking the changes, such that the sender 102 can view who made changes to the document and what the changes were.

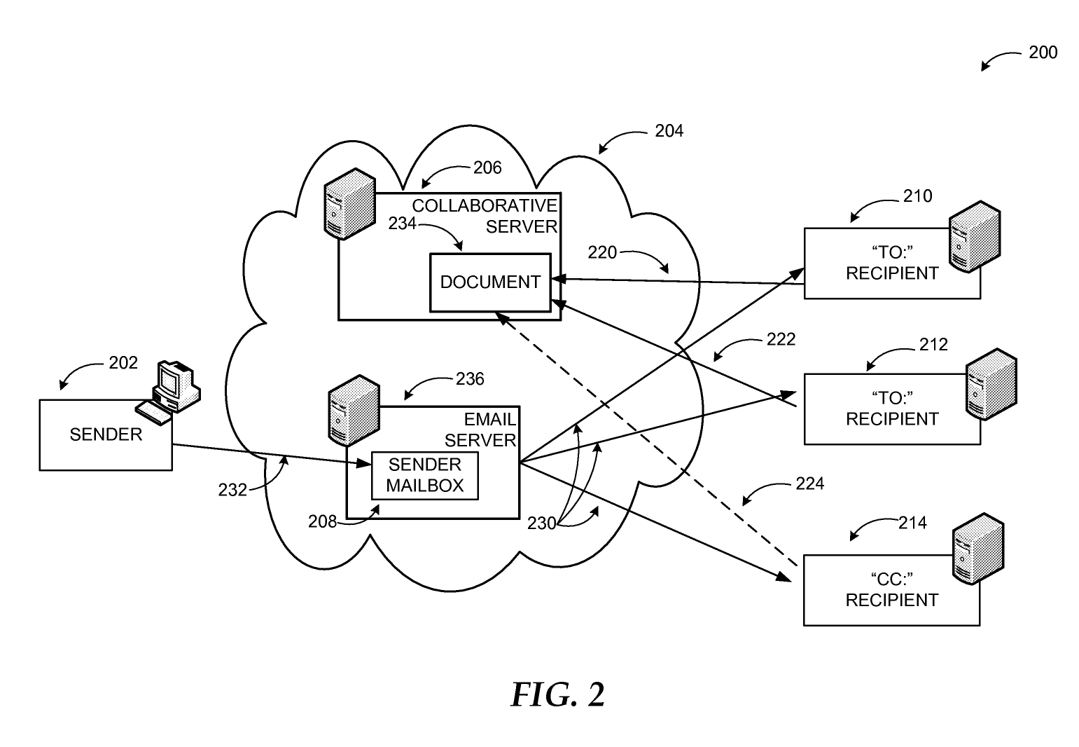

FIG. 2 illustrates a system for automatically configuring document access settings from recipient designations of an email in a collaborative server environment, according to embodiments. In an example embodiment shown in diagram 200, the system may initiate a collaborative authoring environment upon the generation by a sender 202 of an email message (232) including a linked document directed to one or more To: line recipients 210, 212 and one or more CC: line recipients. The document 234 may be stored at a data store of a collaborative server 206 and a link to the document may be inserted to the email message by the sender 102.

Email server 236 may facilitate the email exchange forwarding (230) the email to recipients such as direct recipients 210, 212 (recipients in a To: line of the email) and indirect recipient (recipient in a CC: line or BCC: line of the email) over network(s) 204. Email server 236 may also maintain a mailbox 208 for the sender 202 with the senders email messages, contact information, etc.

Upon the receiving the email message including the document link, recipients 210, 212, and 214 may follow the link and access the document 234 through the collaborative server 206. The recipients access privileges may be enforced by the collaborative server 206 based on their recipient designations as discussed above. The assignment of the access privileges based on the recipient designations may be accomplished by the email server 236 based on the sender's entries in the email message and provided to the collaborative server 206 or determined by the collaborative server 206 based on analyzing the email that includes the link.

Thus, the access and permission settings for the linked document may be automatically configured based on the designated recipients inserted in the To: line and the CC: line and/or BCC: line of the email message. The automatic configuration of the access and permission settings may be transparent to the sender 202 and to the To: line recipients 210, 212 and CC: line recipient 214, such that no input or customization by the sender 202 may be necessary in order to designate the access and permission settings in the collaborative authoring environment.

The To: line recipients 210, 212 may have complete access 220, 222 to the document stored at the collaborative server 206, such that the To: line recipients 210, 212 may make changes to the document, add feedback and comments, and otherwise edit the document using the technology and framework provided by the collaborative server 206. Edits and additions to the document by the To: line recipients 210, 212 may be saved to the document 234 such that the original document is constantly updated with the most recent version of the document when edited by the sender 202 and/or the To: line recipients 210, 212. Additionally, the sender 202 may also be able to make additions and changes to the document in the collaborative environment using the collaborative server 206.

In a further embodiment, recipients in the CC: line or the CC: line recipient 214 may receive the email message that includes the link to the original document stored at the collaborative server 206. When the CC: line recipient 214 receives the email message, the CC: line recipient 214 may click on the document link and be directed to the original document file at the collaborative server 206. The CC: line recipient 214 may have limited or read only access 224 to the document such that the CC: line recipient 214 may be able to access the document to read the document only. With the read only access 224, the CC: line recipient may not be able to make changes to the document, add feedback and comments, or otherwise edit the document. The collaborative environment may enable the CC: line recipient 214 to open the linked document using the collaborative server 206 simultaneously with one or more other To: line recipients 210, 212 in order to view the comments, edits and changes to the document made by the one or more other To: line recipients 110, 112 in current or real time.

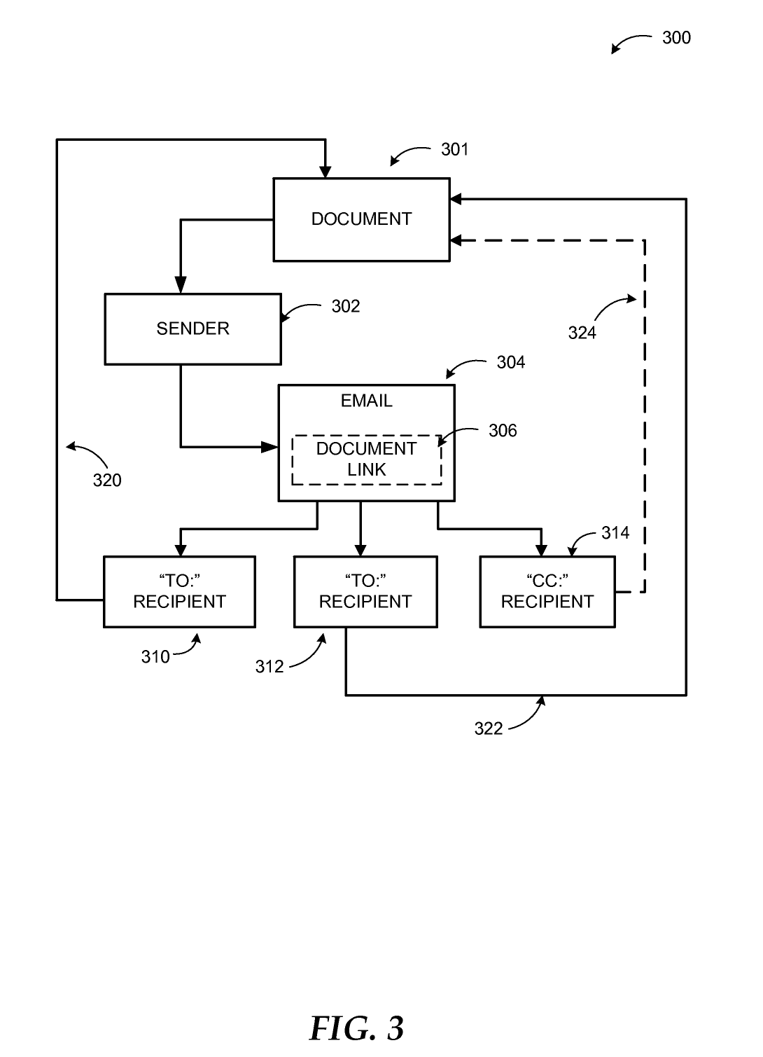

FIG. 3 illustrates an example scenario for automatically configuring document access and permission settings in a collaborative authoring environment, according to embodiments. A document author may create an original document 301, and the document author may wish to collaborate with one or more other users for editing the document 301, and may also wish to receive feedback and comments on the document 301 from one or more other users. The document author may additionally wish to grant certain users read access to the document so that the users may view the document and be aware of edits being made to the document, but the users may not be able to make any changes to the document or leave feedback.

In a system according to embodiments, the system may be configured to automatically grant document access and permission settings upon the initiation of an email message 304 with a link 306 to the document 301 for enabling collaborative editing of the document. The document author, or the sender 302, may generate the email message 304 and may insert the link 306 to the original document 301 in the body of the email message 304. The sender 302 may insert recipient names and/or email address into the To: and CC: line recipient designations of the email message 304. Recipients inserted in the To: line of the email message may be To: line recipients 310, 312, and the system may automatically set the access and permission settings granting the To: line recipients 310, 312 complete access 320, 322 to the original document 301. Additionally, a recipient inserted in the CC: line of the email message may be a CC: line recipient 314, and the system may automatically set the access and permission settings granting the CC: line recipient 314 limited or read only access 324 to the original document 301. The access and permission settings may be automatically configured upon the sending of the email message 304 such that the sender 302 may not have to manually input any special settings into the system for granting user access to the document.

Upon receipt of the email message 304 containing the link 306 to the original document 301, the To: line recipients 310, 312 and the CC: line recipient 314 may be able to click on the link 306 in order to access the original document 301. In an example embodiment, the document 301 may be stored in the sender 302's sender mailbox within an email server, and the link 306 may direct the recipients to the document in the sender mailbox within the email server. In another embodiment, the document 301 may be stored in a collaborative server, which may be accessed over a web browser by multiple users, and the link 306 may direct the recipients to the document in the sender mailbox within the collaborative server. When the To: line recipients 310, 312 click on the link 306 in order to access the original document 301, the To: line recipients 310, 312 may be able to open the original document and may have complete access 320, 322 in order to make additions, changes, and edits and leave feedback on the original document 301. When the CC: line recipient 314 clicks on the link 306 in order to access the original document 301, the CC: line recipient 314 may have limited or read only access 324, such that the CC: line recipient 314 may be able to open the original document 301, and may be able to view the document, but may not be able to make any additions, changes, and edits and leave feedback on the original document 301.

The example systems in FIG. 1 through 3 have been described with specific configurations, applications, and interactions. Embodiments are not limited to systems according to these examples. A system for automatically configuring document access settings from recipient designations of an email in a collaborative authoring environment may be implemented in configurations employing fewer or additional components and performing other tasks. Furthermore, specific protocols and/or interfaces may be implemented in a similar manner using the principles described herein.

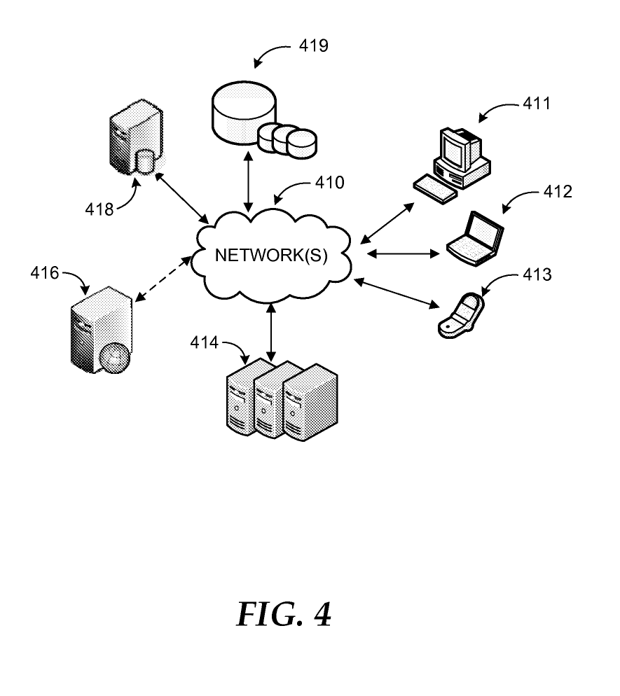

FIG. 4 is an example networked environment, where embodiments may be implemented. A system for automatically configuring document access settings from recipient designations of an email in a collaborative authoring environment may be implemented via software executed over one or more servers 414 such as a hosted service. The platform may communicate with client applications on individual computing devices such as a smart phone 413, a laptop computer 412, or desktop computer 411 (‘client devices’) through network(s) 410.

Client applications executed on any of the client devices 411-413 may facilitate communications via application(s) executed by servers 414, or on individual server 416. An application executed on one of the servers may facilitate initiating a collaborative authoring environment upon generation of an email message and automatically configuring access and permission settings for recipients of the email message. The application may designate recipients in the To: line of the email message as To: line recipients and may automatically grant complete access for authoring and editing a document in the email message to the To: line recipients. The application may also designate recipients in the CC: line of the email message as CC: line recipients and automatically grant limited or read only access for reading and viewing the document in the email message. The CC: line recipients may not be granted any authoring, editing, or commenting access to the document. The system may automatically grant the access and permission settings upon the sending of the email message and may not require any input by the sender. The application may retrieve relevant data from data store(s) 419 directly or through database server 418, and provide requested services (e.g. document editing) to the user(s) through client devices 411-413.

Network(s) 410 may comprise any topology of servers, clients, Internet service providers, and communication media. A system according to embodiments may have a static or dynamic topology. Network(s) 410 may include secure networks such as an enterprise network, an unsecure network such as a wireless open network, or the Internet. Network(s) 410 may also coordinate communication over other networks such as Public Switched Telephone Network (PSTN) or cellular networks. Furthermore, network(s) 410 may include short range wireless networks such as Bluetooth or similar ones. Network(s) 410 provide communication between the nodes described herein. By way of example, and not limitation, network(s) 410 may include wireless media such as acoustic, RF, infrared and other wireless media.

Many other configurations of computing devices, applications, data sources, and data distribution systems may be employed to implement a platform for automatically configuring document access settings from recipient designations of an email message in a collaborative authoring environment. Furthermore, the networked environments discussed in FIG. 4 are for illustration purposes only. Embodiments are not limited to the example applications, modules, or processes.

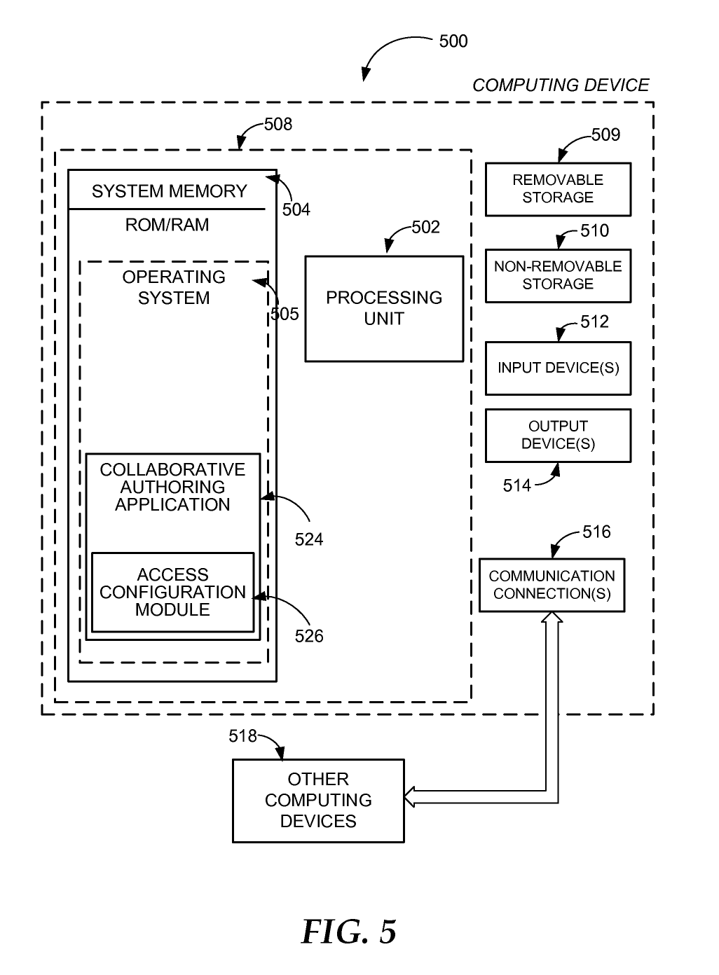

FIG. 5 and the associated discussion are intended to provide a brief, general description of a suitable computing environment in which embodiments may be implemented. With reference to FIG. 5, a block diagram of an example computing operating environment for an application according to embodiments is illustrated, such as computing device 500. In a basic configuration, computing device 500 may be any computing device executing an application for providing collaborative authoring services according to embodiments and include at least one processing unit 502 and system memory 504. Computing device 500 may also include a plurality of processing units that cooperate in executing programs. Depending on the exact configuration and type of computing device, the system memory 504 may be volatile (such as RAM), non-volatile (such as ROM, flash memory, etc.) or some combination of the two. System memory 504 typically includes an operating system 505 suitable for controlling the operation of the platform, such as the WINDOWS ® operating systems from MICROSOFT CORPORATION of Redmond, Wash. The system memory 504 may also include one or more software applications such as a collaborative authoring application 524 and an access configuration module 526.

The collaborative authoring application 522 may facilitate initiating a collaborative authoring environment upon the generation of an email including a link to a document. The application may designate recipients in the To: line of the email message as To: line recipients and may also designate recipients in the CC: line of the email message as CC: line recipients. The collaborative authoring application 524 may enable two or more users, including the sender, To: line recipients, and CC: line recipients to simultaneously access the document using the document link in the email message. Access configuration module 526, which may be a distinct application or an integrated module of collaborative authoring application 524, may automatically configure access and permission settings for recipients of the email message based on the recipient line in which the recipient is inserted in the email message. The access configuration module 526 may automatically grant complete access for authoring and editing a document in the email message to the To: line recipients. Additionally, the access configuration module 526 may automatically grant limited or read only access for reading and viewing the document in the email message. The CC: line recipients may not be granted any authoring, editing, or commenting access to the document. The system may transparently and automatically grant the access and permission settings upon the sending of the email message and may not require any input by the sender. This basic configuration is illustrated in FIG. 5 by those components within dashed line 508.

Computing device 500 may have additional features or functionality. For example, the computing device 500 may also include additional data storage devices (removable and/or non-removable) such as, for example, magnetic disks, optical disks, or tape. Such additional storage is illustrated in FIG. 5 by removable storage 509 and non-removable storage 510. Computer readable storage media may include volatile and nonvolatile, removable and non-removable media implemented in any method or technology for storage of information, such as computer readable instructions, data structures, program modules, or other data. System memory 504, removable storage 509 and non-removable storage 510 are all examples of computer readable storage media. Computer readable storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and which can be accessed by computing device 500. Any such computer readable storage media may be part of computing device 500. Computing device 500 may also have input device(s) 512 such as keyboard, mouse, pen, voice input device, touch input device, and comparable input devices. Output device(s) 514 such as a display, speakers, printer, and other types of output devices may also be included. These devices are well known in the art and need not be discussed at length here.

Computing device 500 may also contain communication connections 516 that allow the device to communicate with other devices 518, such as over a wired or wireless network in a distributed computing environment, a satellite link, a cellular link, a short range network, and comparable mechanisms. Other devices 518 may include computer device(s) that execute communication applications, web servers, and comparable devices. Communication connection(s) 516 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

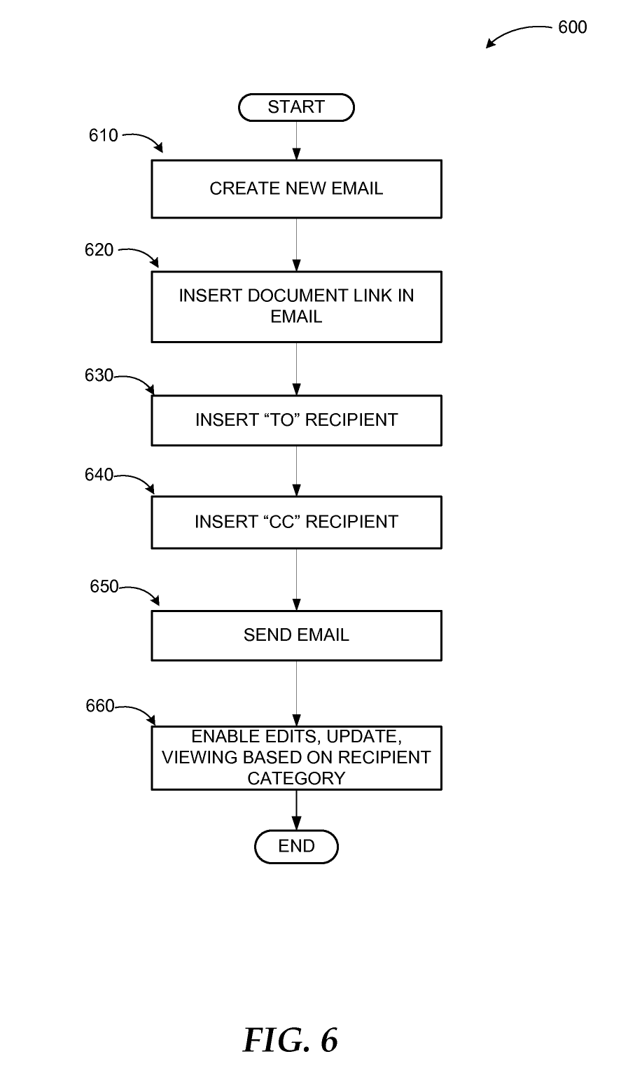

FIG. 6 illustrates a logic flow diagram for process 600 of automatically configuring document access settings from recipient designations of an email in a collaborative authoring environment according to embodiments. Process 600 may be implemented on a computing device or similar electronic device capable of executing instructions through a processor.

Process 600 begins with operation 610, where a sender may create a new email message for sending to users with which the sender desires to collaborate with on a document or file. At operation 620, the sender may insert a link to the document into the body of the email message. The document may be stored in the sender's mail box in an email server, or the document may alternatively be stored in a collaborative server accessed over a web browser. At operation 630 the sender may insert the users' names and/or email addresses into recipient designations in the email message. Recipient designations of the email message may include a To: line, a CC: line and/or a BCC: line.

At operation 630 the sender may insert users' names and/or email addresses into the To: line recipient line of the email message. The users in the To: line recipient line of the email message, or the To: line recipients, may be users to which the sender wishes to directly send the email message, and whom the sender wishes to have authoring capabilities. The To: line recipient line may be configured to automatically grant a To: line recipient full viewing and editing access to the linked document for complete collaborative authoring and editing capabilities. At operation 640 the sender may insert users' names and/or email addresses into the CC: line recipient line of the email message. The users in the CC: line recipient line of the email message, or the CC: line recipients, may be users to which the sender wishes to indirectly send the email message, and whom the sender wishes to have read only capabilities and no authoring capabilities. The CC: line may be configured to automatically grant a CC: line recipient limited or read only access to the linked document for read only capabilities.

At operation 650 the sender may send the email message containing the document link to the To: line recipients and the CC: line recipients. Upon receipt of the email message, the To: line recipients and the CC: line recipients may click on the link and be directed to the document where it is stored for access to the document. The To: line recipients may have complete access for editing and leaving comments to the document. The CC: line recipients may have limited read only access for reading the document and viewing edits to the document made by the To: line recipients. At operation 660 any edits, comments and/or feedback made to the document may be received, and the document may be updated with collaborative edits and stored in the server.

The operations included in process 600 are for illustration purposes. Automatically configuring document access settings from recipient designations of an email in a collaborative authoring environment may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part in a computing device for automatically configuring document access settings from recipient designations of an email in a collaborative authoring environment, the method comprising:
enabling a sender to generate an email message associated with a document;
receiving one or more direct recipients for the email message;
receiving one or more indirect recipients for the email message; and
transmitting the email message to the direct and indirect recipients such that access privileges of a recipient for the document are defined based on whether the recipient is one of a direct recipient and an indirect recipient.

2. The method of claim 1, further comprising:
enabling the sender to associate the email message with the document by one of inserting the document into the email message and inserting a link to the document into the email message.

3. The method of claim 1, wherein the direct recipients are recipients of the email message listed in a To: line of the email message and the indirect recipients are recipients of the email message in one of a CC: line and a BCC: line of the email message.

4. The method of claim 3, further comprising:
automatically granting complete access to the document for the one or more recipients in the To: line of the email message.

5. The method of claim 4, wherein the complete access includes at least one from a set of: read, edit, download, forward, delete, and store privileges.

6. The method of claim 3, further comprising:
automatically granting limited access to the document for the one or more recipients in one of the CC: line and the BCC: line of the email message.

7. The method of claim 6, wherein the limited access includes read privileges.

8. The method of claim 1, further comprising:
storing the document in a mailbox associated with the sender at an email service provider; and
enabling the recipients access the document from the mailbox associated with the sender.

9. The method of claim 1, further comprising:
storing the document at a data store associated with a collaborative authoring service provider; and
enabling the recipients access the document from the data store associated with a collaborative authoring service provider.

10. The method of claim 1, further comprising:
enabling two or more of the direct recipients to have complete access to the document for authoring and editing the document concurrently.

11. The method of claim 1, further comprising:
enabling one or more of the indirect recipients to have read-only access to the document simultaneously with one or more of the direct recipients for viewing edits made to the document by the one or more direct recipients in real time.

12. A system for automatically configuring document access settings from recipient designations of an email in a collaborative authoring environment, comprising:
an email server configured to:
enable a sender to generate an email message associated with a document by providing a link to the document;
receive one or more direct recipients for the email message;
receive one or more indirect recipients for the email message; and
transmit the email message to the direct and indirect recipients; and
a collaboration server configured to:
store the document;
enable access to the document through the link such that access privileges of a recipient for the document are defined based on whether the recipient is one of a direct recipient and an indirect recipient.

13. The system of claim 12, wherein the collaboration server determines the access privileges by one of: analyzing recipient designations of the email message and receiving access privilege instructions from the email server.

14. The system of claim 12, wherein the direct recipients are recipients of the email message listed in a To: line of the email message and the indirect recipients are recipients of the email message in one of a CC: line and a BCC: line of the email message, and the collaboration server is further configured to:
automatically grant complete access to the document for the one or more recipients in the To: line of the email message; and
automatically grant limited access to the document for the one or more recipients in one of the CC: line and the BCC: line of the email message.

15. The system of claim 14, wherein the collaboration server is further configured to:
enable the sender to customize the access privileges for one or more of the CC: and To: line recipients.

16. The system of claim 14, wherein the collaboration server is further configured to:
track changes to the document made by the one or more direct recipients with complete access to the document.

17. The system of claim 12, wherein the document is one of: a word processing document, a spreadsheet, an image, a video, a presentation document, a graphic design document, a calendar document, and an email message.

18. A computer-readable storage medium with instructions stored thereon for automatically configuring document access settings from recipient designations of an email in a collaborative authoring environment, the instructions comprising:
enabling a sender to generate an email message;
enabling the sender to associate the email message with a document by one of inserting the document into the email message and inserting a link to the document into the email message;
receiving one or more recipients in a To: line of the email message;
receiving one or more recipients in a CC: line of the email message; and
transmitting the email message to the recipients such that access privileges for the document of a recipient are defined based on whether the recipient is in one of the To: line and the CC: line.

19. The computer-readable medium of claim 18, wherein the instructions further comprise:
automatically grant at least one from a set of: read, edit, download, forward, delete, and store privileges to the document for the one or more recipients in the To: line of the email message; and
automatically grant read-only access to the document for the one or more recipients in one of the CC: line and a BCC: line of the email message.

20. The computer-readable medium of claim 19, wherein the instructions further comprise one of:
enabling the recipients access the document through a mailbox associated with the sender; and
enabling the recipients access the document through a data store associated with a collaborative authoring service provider.
